(19) United States
(12) Patent Application Publication
(10) Pub. No.: US 2025/0313488 A1
(43) Pub. Date: Oct. 9, 2025

(54) METHOD OF MAKING TiO2 NANOSHEETS USING AN AIR-GAP ASSISTED SOLVOTHERMAL PROCESS

(71) Applicant: KING FAHD UNIVERSITY OF PETROLEUM AND MINERALS, Dhahran (SA)

(72) Inventors: Nadeem BAIG, Dhahran (SA); Billel SALHI, Dhahran (SA); Ismail ABDULAZEEZ, Dhahran (SA)

(73) Assignee: KING FAHD UNIVERSITY OF PETROLEUM AND MINERALS, Dhahran (SA)

(21) Appl. No.: 18/627,998

(22) Filed: Apr. 5, 2024

(51) Int. Cl. C01G 23/047; C02F 1/461; C02F 101/10

(52) U.S. Cl. CPC C01G 23/047; C02F 1/46109; C01P 2002/01; C01P 2002/72; C01P 2002/82; C01P 2002/85; C01P 2004/04; C01P 2004/24; C01P 2004/51; C01P 2004/61; C01P 2006/12; C02F 2001/46133; C02F 2101/10

(57) ABSTRACT

A method of making TiO₂ nanosheets including heating a titanium (IV) alkoxide in a solvent to a temperature of 70-100° C. for 10-100 minutes to form a heated titanium (IV) alkoxide, reacting the heated titanium (IV) alkoxide in a solvothermal autoclave for 12-60 hours at a temperature of 100-200° C. to form a reaction mixture. The solvothermal autoclave has an air gap of 20-95 vol % relative to a total volume of the solvothermal autoclave. The method further includes separating the TiO₂ nanosheets from the reaction mixture. The length and a width of the TiO₂ nanosheets are greater than 1 μm, and the TiO₂ nanosheets have a BET surface area of 900-1,000 m²/g.

### STATEMENT OF PRIOR DISCLOSURE BY INVENTOR

Aspects of the present disclosure are described in B. Salhi, N. Baig, and I. Abdulazeez “Air-gap-assisted solvothermal process to synthesize unprecedented graphene-like two-dimensional TiO₂ nanosheets for Na⁺ electrosorption/desalination”; 2024; Clean Water; 7; 9, incorporated herein by reference in its entirety.

### STATEMENT OF ACKNOWLEDGEMENT

Support provided by the e Interdisciplinary Research Center for Membranes and Water Security at King Fahd University of Petroleum and Minerals under grant number INMW2315 is gratefully acknowledged.

### BACKGROUND

### Technical Field

The present disclosure is directed to a method of making TiO₂ nanosheets, particularly to a method of making TiO₂ nanosheets using an air-gap assisted solvothermal process.

### Description of Related Art

The “background” description provided herein is to present the context of the disclosure generally. Work of the presently named inventors, to the extent it is described in this background section, as well as aspects of the description that may not otherwise qualify as prior art at the time of filing, are neither expressly nor impliedly admitted as prior art against the present invention.

Fresh water shortage has emerged as a major worldwide concern, therefore, developing water scarcity mitigation techniques is needed. Given that more than 97 percent of Earth's water is saline, desalination of seawater or brackish water is a potentially viable method for ensuring a sustainable freshwater supply. Desalination methods, including reverse osmosis (RO), electrodialysis (ED), multistage flash, and multi-effect distillation, have improved rapidly in recent years. However, traditional desalination processes are extremely energy intensive. RO requires a high osmotic pressure (1-10 MPa) for salt separation and is associated with membrane fouling problems. Thermal desalination procedures require a large amount of heat for water vaporization and are frequently limited by equipment corrosion. Extremely high voltages (>20 V) are used in ED to promote ion mobility for separation, which may result in water breakdown. Therefore, there exists a need for new high-efficiency desalination methods that are energy-efficient and ecologically benign.

Owing to its energy efficiency, cost-effectiveness, and eco-friendliness, capacitive deionization (CDI) has emerged as a promising desalination technique in recent years. In principle, the CDI is explained by the adsorption and desorption processes on the electrode surface under the influence of electrostatic force. The salt ions are adsorbed on the charged electrode surface, forming the electrical double layer. The electrode surface can be regenerated easily just by reversing the polarity. During the regeneration process, the ions desorb from the electrode surface, and the surface becomes ready for the next cycle. CDI systems can function at low pressures (sub-osmotic) and ambient temperatures while using a low applied cell voltage (2 V). CDI selectively removes the minority salt ions from the saline solution rather than the majority water, making it suitable for efficiently desalinating low-salinity streams such as brackish water, which typically contains total dissolved salts (TDS) ranging from 1 g L⁻¹ to 10 g L⁻¹ (compared to seawater TDS of 35 g L⁻¹). CDI consumes only 0.13-0.59 kWh m 3 for brackish water desalination. This is much lower than that of RO, the most energy-efficient classical desalination technique, which consumes 3.5-4.5 kWh m⁻³.

The electrode material plays a central role in the CDI. Thus, most research is focused on developing an electrode material that offers greater electrochemical stability, excellent electrical conductivity, good wettability, and high capacitance. The role of electrode materials in desalination can be understood by focusing on ion capture mechanisms. Electrosorption and Faradaic reactions are the two primary ion capture processes in CDI. Electrosorption occurs in standard CDI cells with carbon electrodes, where the potential difference is responsible for the adsorption of salt ions with opposing charges from the solution onto the surface of the carbon materials. The Faradaic mechanism occurs in Faradaic materials and consists of several processes: insertion and conversion reactions, ion-redox active moiety interactions, and charge compensation with a redox-active electrolyte; unlike those used in electrosorption, Faradaic electrode materials capture ions via Faradaic processes that occur throughout the bulk material and extend beyond the surface.

The use of anatase TiO₂ in CDI has been the subject of numerous studies however, there are several limitations, such as low electronic conductivity and slow ion diffusion. The production of nanosized TiO₂ and the fusion of TiO₂ with carbon-based substrates such as hollow carbon fibers, activated carbon, graphene, and multiwalled carbon nanotubes (MWCNTs) are two methods that have been investigated to improve the performance, yet this requires strong annealing and harsh conditions to activate the TiO₂. 2D sheets of TiO₂ can be effective in the intercalation and de-intercalation of ions on demand; however, the synthesis of 2D sheets of anatase-TiO₂, such as star graphene-like materials, is challenging.

Accordingly, an object of the present disclosure is directed to a process of preparing high-quality graphene-like anatase-2D TiO₂ nanosheets using a simple and cost-effective method. It is another object of the present disclosure to use the 2D TiO₂ nanosheets for water desalination.

### SUMMARY

In an exemplary embodiment, a method of making TiO₂ nanosheets is described. The method includes heating a titanium (IV) alkoxide in a solvent to a temperature of 70-100° C. for 10-100 minutes to form a heated titanium (IV) alkoxide; reacting the heated titanium (IV) alkoxide in a solvothermal autoclave for 12-60 hours at a temperature of 100-200° C. to form a reaction mixture; and separating the TiO₂ nanosheets from the reaction mixture. The solvothermal autoclave has an air gap of 20-95 vol % relative to a total volume of the solvothermal autoclave. The length and width of the TiO₂ nanosheets are greater than 1 μm, and the TiO₂ nanosheets have a BET surface area of 900-1,000 square meters per gram (m²/g).

In some embodiments, a thickness of the TiO₂ nanosheets of less than 3 nm.

In some embodiments, the TiO₂ nanosheets are layered on top of one another with an average interlayer spacing of 0.25-0.5 nanometers (nm).

In some embodiments, the TiO₂ nanosheets comprise wrinkles.

In some embodiments, the TiO₂ nanosheets have an average pore size of 0.4-1.0 nm.

In some embodiments, the TiO₂ nanosheets comprise anatase TiO₂.

In some embodiments, the TiO₂ nanosheets do not comprise rutile or brookite TiO₂.

In some embodiments, the TiO₂ nanosheets have an average crystallite size of 1-2.5 nm.

In some embodiments, the TiO₂ nanosheets are at least 30% crystalline.

In some embodiments, the TiO₂ nanosheets comprise both TiO₂ and Ti₂O₃.

In another exemplary embodiment, the TiO₂ nanosheets are made by the method of present disclosure.

In yet another exemplary embodiment, an electrode is described. The electrode includes the TiO₂ nanosheets, and a substrate. The TiO₂ nanosheets are dispersed on a surface of the substrate.

In another exemplary embodiment, a method of desalinating an aqueous solution is described. The method includes applying a potential of −0.1 to −2.0 V to an electrochemical cell comprising the electrode and a counter electrode. The electrochemical cell is at least partially submerged in the aqueous solution. On applying the potential, at least a portion of ions in the aqueous solution adsorb to the electrode.

In some embodiments, the electrode has a specific capacitance of 40-50 Farad per gram (F/g).

In some embodiments, the specific capacitance does not change by more than 10% following 10,000 charge-discharge cycles.

In some embodiments, at least a portion of the ions are sodium ions, and on applying the potential, sodium titanate is formed.

In some embodiments, the electrode has an ion adsorption capacity of 30-40 mg per gram of the TiO₂ nanosheets.

In some embodiments, the aqueous solution has an ion concentration of 1-10,000 mg/L.

The foregoing general description of the illustrative present disclosure and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a flowchart depicting a method of making TiO₂ nanosheets, according to certain embodiments.

FIG. 2A shows X-ray diffractogram (XRD) pattern of samples (S1, S2, S3, and S4) of the TiO₂ nanosheets, according to certain embodiments.

FIG. 2B shows Raman spectra of the samples, according to certain embodiments.

FIG. 2C shows Fourier transform-infrared (FTIR) spectra of the samples, according to certain embodiments.

FIG. 2D shows X-ray photoelectron spectra (XPS) of the samples, according to certain embodiments.

FIG. 2E depicts high-resolution XPS spectra of Ti 2p, according to certain embodiments.

FIG. 2F depicts high-resolution XPS spectra of O 1s, according to certain embodiments.

FIGS. 3A-3D depict transmission electron microscope (TEM) images of the samples, S1, S2, S3, and S4, respectively, according to certain embodiments.

FIG. 4A shows a high-resolution transmission electron microscope (HRTEM) image of the lattice fringes of the TiO₂ nanosheets for the sample S4, according to certain embodiments.

FIGS. 4B-4D show the lattice spacing of the TiO₂ nanosheets for the sample S4 at the (101), (200), and (001) planes, respectively, according to certain embodiments.

FIG. 5A shows N₂ sorption isotherms of the sample S1 and the sample S4 at 77 K, according to certain embodiments.

FIG. 5B shows pore size distribution of the sample S4 estimated by the non-linear density functional theory (DFT), according to certain embodiments.

FIG. 6A shows cyclic voltammetry (CV) curves of the 2D TiO₂ nanosheets at different scan rates, according to certain embodiments.

FIG. 6B shows CV curves of the 2D TiO₂ nanosheets prepared under different preparation conditions, according to certain embodiments.

FIG. 6C shows galvanostatic charge-discharge (GCD) profiles of the 2D TiO₂ nanosheets at different specific current densities, according to certain embodiments.

FIG. 6D shows GCD curves of the 2D TiO₂ nanosheets from the first to 10000th cycle at a specific current of 100 mA g⁻¹, according to certain embodiments.

FIG. 6E shows capacitive and diffusion contributions of the 2D TiO₂ nanosheets at 100 mVs⁻¹, according to certain embodiments.

FIG. 6F shows contribution ratio of capacitive capacities of the 2D TiO₂ nanosheets at different scan rates, according to certain embodiments.

FIG. 7A is a plot of trend of conductivity versus time, indicating adsorption and desorption of Nations on a 2D TiO₂ electrode, according to certain embodiments.

FIG. 7B is a plot of long-term salt adsorption capacity with the 2D TiO₂ electrode, according to certain embodiments.

FIG. 7C is a plot of salt adsorption capacity (SAC) at different cutoff voltage ranges with the 2D TiO₂ electrode, according to certain embodiments.

FIG. 7D shows a plot of salt adsorption rate of the 2D TiO₂ electrode at different cutoff voltage ranges, according to certain embodiments.

FIG. 7E shows SAC at different Na⁺ concentrations with the 2D TiO₂ electrode, according to certain embodiments.

### DETAILED DESCRIPTION

In the drawings, reference numerals designate identical or corresponding parts throughout the several views. Further, as used herein, the words “a,” “an,” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), +/−15% of the stated value (or range of values), or +/−20% of the stated value (or range of values). Within the description of this disclosure, where a numerical limit or range is stated, the endpoints are included unless stated otherwise. Also, all values and subranges within a numerical limit or range are specifically included as if explicitly written out.

The use of the terms “include,” “includes”, “including,” “have,” “has,” or “having” should be generally understood as open-ended and non-limiting unless specifically stated otherwise. The present disclosure is intended to include all hydration states of a given compound or formula, unless otherwise noted or when heating a material.

Aspects of the present disclosure are directed to a method for synthesizing two-dimensional (2D) titanium dioxide (TiO₂) graphene-like nanosheets via an air-gap-assisted solvothermal method. The phase structure and the crystallinity of the 2D-TiO₂ nanosheets were controlled by tuning the free space inside the solvothermal reactor—to yield the 2D-TiO₂ nanosheets of the anatase TiO₂ phase with high crystallinity. The 2D-TiO₂ nanosheets prepared by the method of present disclosure obviate the need for the use of expensive reactants/harsh reaction conditions. The prepared nanosheets were used as a Faradaic electrode and were further evaluated for their potential in desalination. The results indicate that the electrochemical performance of the 2D-TiO₂ nanosheets prepared by the method of present disclosure demonstrated excellent electrochemical stability and improved desalination.

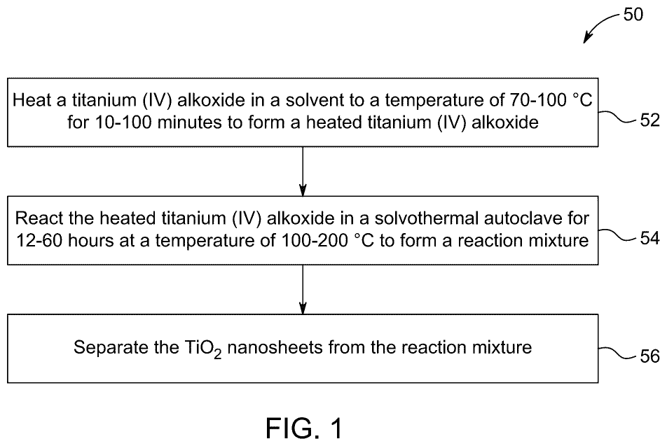

FIG. 1 illustrates a flow chart of method 50 for making TiO₂ nanosheets. The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure.

At step 52, the method 50 includes heating a titanium (IV) alkoxide in a solvent to a temperature of 70-100° C., preferably 75-95° C., preferably 80-90° C., preferably 80° C. for 10-100 minutes, preferably 20-90 minutes, preferably 30-80 minutes, preferably 30 minutes, to form a heated titanium (IV) alkoxide. The titanium alkoxide is represented by the chemical structure Ti(OR₁)(OR₂)(OR₃)(OR₄), where R₁ to R₄ are the same or different alkyl groups. In an embodiment, R₁ to R₄ is an alkyl group having 1-10 carbon atoms, preferably 1-6 carbon atoms, and yet more preferably 2-4 carbon atoms. Suitable examples of titanium (IV) alkoxides include titanium (IV) isopropoxide, titanium (IV) n-butoxide, titanium (IV) methoxide, titanium (IV) ethoxide, titanium (IV) n-propoxide, and/or combinations thereof. In a preferred embodiment, the titanium (IV) alkoxide is titanium (IV) isobutoxide.

The titanium (IV) alkoxide is dissolved in a solvent before heating. The purpose of heating the titanium (IV) alkoxide in the solvent is to ensure better dissolution of the titanium (IV) alkoxide in the solvent. The solvent may be organic or inorganic. In an embodiment, the solvent is an organic solvent, preferably an aprotic solvent. Suitable examples of the aprotic solvents may include ether solvents, tetrahydrofuran (THF), dimethylformamide (DMF), 1,2-dimethoxyethane (DME), diethoxy methane, dimethoxymethane, dimethylacetamide (DMAC), benzene, toluene, 1,3-dimethyl-3,4,5,6-tetrahydro-2 (1H)-pyrimidinone (DMPU), 1,3-dimethyl-2-imidazolidinone (DMI), N-methyl pyrrolidinone (NMP), formamide, N-methyl acetamide, N-methyl formamide, acetonitrile, dimethyl sulfoxide, propionitrile, ethyl formate, methyl acetate, hexachloroacetone, acetone, ethyl methyl ketone, ethyl acetate, sulfolane, N,N-dimethylpropionamide, tetramethylurea, nitromethane, nitrobenzene, or hexamethylphosphoramide. In a preferred embodiment, the solvent is DMF. In some embodiments, the heating may be carried out at temperatures slightly beyond the prescribed ranges, with the temperature range dependent on the choice of the titanium (IV) alkoxide and the solvent.

At step 54, the method 50 includes reacting the heated titanium (IV) alkoxide in a solvothermal autoclave for 12-60, preferably 24-55 hours, preferably 30-50 hours, preferably 40-50 hours, preferably to about 48 hours at a temperature of 100-200° C., preferably 110-190° C., preferably 120-180° C., preferably 130-170° C., preferably 140-160° C., preferably to about 150° C. to form a reaction mixture. This is referred to as a solvothermal reaction, where the reaction takes place in a solvent at a temperature higher than the boiling temperature of the solvent in a sealed vessel. It is preferred to carry out the solvothermal reaction in a solvothermal autoclave or any other pressure container to prevent/minimize the formation of undesirable polymorphic forms of TiO₂. The solvothermal autoclave is made up of a strong alloy, such as steel, to withstand the pressure developed during the reaction. Generally, the solvothermal autoclave contains a Teflon (PTFE, polytetrafluoroethylene) liner to protect it from corrosion and to provide a chemically inert vessel for the reaction. In some embodiments, the solvothermal reactions can be performed in conventional ovens/microwave ovens.

One of the parameters that affect the morphology and phase formation of the TiO₂ nanosheets, in addition to the choice of solvent, precursor, reaction temperature, and reaction pressure, is the autoclave fill factor (free space/air-gap/free volume in the solvothermal reactor). Generally, it is preferred that less than 70%, preferably 60%, preferably 50%, preferably 40%, preferably 30%, preferably 20%, preferably 10%, preferably 9%, preferably 8%, and more preferably 7% of the autoclave volume is filled with the heated titanium (IV) alkoxide. The solvothermal autoclave has an air gap of 25-250 mL, preferably 50-250 mL, preferably 100-250 mL, and more preferably of about 250 mL. In some embodiments, the solvothermal autoclave has an air gap of 5-95 vol %, 10-90 vol %, 15-85 vol %, 20-80 vol %, 25-75 vol %, 30-70 vol %, 35-65 vol %, 40-60 vol %, 45-55 vol %, or about 50 vol %, relative to a total volume of the solvothermal autoclave. The solvothermal reaction results in the formation of the reaction mixture, which includes the TiO₂ nanosheets.

At step 56, the method 50 includes separating the TiO₂ nanosheets from the reaction mixture. The TiO₂ nanosheets may be separated by any of the separation techniques known in the art, e.g., internal and external filtration, natural and forced sedimentation, magnetic separation, vacuum distillation, and chemical conversion. In a preferred embodiment, the TiO₂ nanosheets are separated from the reaction mixture via centrifugation. After separation, the TiO₂ nanosheets may be washed with a suitable solvent to remove any impurities/traces of the reactant mixture. The solvent used for centrifugation may be water, alcohol, or ether, preferably alcohol—for example, methanol, ethanol, propanol, butanol, and isopropanol), and more preferably methanol.

In a preferred embodiment, the TiO₂ nanosheets have a 2D structure where the nanosheets are thin and grow only length and width wise. The length and width of the TiO₂ nanosheets prepared by the method of present disclosure are greater than 1 μm, preferably 1-10 μm, 2-9 μm, 3-8 μm, 4-7 μm, or 5-6 μm. The TiO₂ nanosheets have a thickness of less than 3 nm, preferably 1-3 nm, preferably 0.5-1.5 nm, or about 1 nm.

In some embodiments, the TiO₂ nanosheets are layered on top of one another with an average interlayer spacing of 0.25-0.5 nm, preferably 0.3-0.4 nm, preferably 0.34-0.35 nm. In some embodiments, the TiO₂ nanosheets have a substantially similar structure to that of graphene. In some embodiments, the TiO₂ nanosheets have wrinkles. In some embodiments, the wrinkles are on at least 50%, preferably 60%, 70%, 80%, or 90% of a surface area of the TiO₂ nanosheets. In some embodiment, the wrinkles increase the surface area of the TiO₂ nanosheets. In some embodiments, the TiO₂ nanosheets have a Brunauer-Emmett-Teller (BET) surface area of 900-1,000 m²/g, preferably 910-990 m²/g, 920-980 m²/g, 930-970 m²/g, 930-960 m²/g, 930-950 m²/g, preferably 930-940 m²/g, preferably 934 m²/g. In some embodiments, the TiO₂ nanosheets have an average pore size of 0.4-1.0 nm, preferably 0.5-0.9, or 0.6-0.8 nm.

In a preferred embodiment, at least 60%, preferably 65%, preferably 70%, preferably 75%, preferably 80%, preferably 85%, preferably 90%, preferably 95%, and preferably 100% of the TiO₂ nanosheets are anatase phase and have a rutile or brookite TiO₂ of less than 5%, preferably 4%, preferably 3%, preferably 2%, preferably 1%, preferably 0.5%, preferably 0.3%, preferably 0.1. %, and yet more preferably with no traces of rutile or brookite phases of TiO₂. In an embodiment, at least 30%, preferably 40%, 50%, 60%, 70%, 80%, 90%, or 100% of the TiO₂ nanosheets have a crystalline structure as opposed to amorphous. In some embodiments, the crystallinity increases with an increasing air gap in the solvothermal synthesis. In some embodiments, the TiO₂ nanosheets have an average crystallite size of 1-2.5 nm, preferably 1.2-2.4 nm, preferably 1.3-2.1 nm, and yet more preferably 1.33-2.01 nm.

The titanium in the TiO₂ nanosheets may exist in various oxidation states of +3 and +4 as dititanium trioxide (Ti₂O₃), and titanium dioxide (TiO₂), respectively. In a preferred embodiment, less than 10%, preferably 8%, 6%, 4%, or 2% of the Ti in the nanosheets is Ti₂O₃.

The TiO₂ nanosheets prepared by the method of present disclosure can be used as an electrode. Accordingly, another aspect of the present disclosure is directed to an electrode. The electrode includes a substrate, and the TiO₂ nanosheets are dispersed on the substrate. The substrate may be made from at least one material selected from conductive carbon, stainless steel, aluminum, nickel, copper, platinum, zinc, tungsten, and titanium. In a specific embodiment, the substrate is conductive carbon paper. Carbon papers possess unique properties, such as high electrical conductivity, mechanical strength, and chemical resistance.

The TiO₂ nanosheets cover at least 50%, preferably 55%, preferably 60%, preferably 65%, preferably 70%, preferably 75%, preferably 80%, preferably 85%, preferably 90%, and preferably >95% of the substrate. In some embodiments, the TiO₂ nanosheets are dispersed on the surface of the substrate using a drop-casting method. Alternate techniques for depositing the TiO₂ nanosheets on the substrate include spray coating, spin coating, and dip coating.

A method of desalinating an aqueous solution with the TiO₂ nanosheets-based electrode is described. The method of desalinating the aqueous solution includes applying a potential of −0.1 to −2.0 V, preferably −0.2 to −1.8 V, preferably −0.4 to −1.6 V, preferably −0.6 to −1.4 V, and preferably −0.8 to −1.2 V vs RHE to an electrochemical cell. A negative voltage is applied to the working electrode, and a positive voltage is applied to the counter electrode. The electrochemical cell includes a working electrode, a counter electrode, and optionally a reference electrode. The working electrode includes the TiO₂ nanosheets dispersed on the conductive carbon. The counter electrode may contain an electrically-conductive material such as platinum, platinum-iridium alloy, iridium, titanium, titanium alloy, stainless steel, gold, cobalt alloy, and/or some other electrically-conductive material, where an “electrically-conductive material” as defined here is a substance with an electrical resistivity of at most 10⁻⁶ ohms meter (Ω·m), preferably at most 10⁻⁷ Ω·m, more preferably at most 10⁻⁸ Ω·m at a temperature of 20-25° C. The form of the counter electrode may be generally relevant only in that it needs to supply sufficient current to the electrolyte solution to support the current required for the electrochemical reaction of interest. The material of the counter electrode should thus be sufficiently inert to withstand the chemical conditions in the electrolyte solution, such as acidic or basic pH values, without substantially degrading during the electrochemical reaction. The counter electrode preferably should not leach out any chemical substance that interferes with the electrochemical reaction or might lead to undesirable contamination of either electrode. In a preferred embodiment, the counter electrode is platinum mesh.

The electrochemical cell further includes a reference electrode in contact with the electrolyte solution. A reference electrode is an electrode that has a stable and well-known electrode potential. The high stability of the electrode potential is usually reached by employing a redox system with constant (buffered or saturated) concentrations of each relevant species of the redox reaction. A reference electrode may enable a potentiostat to deliver a stable voltage to the working electrode or the counter electrode. The reference electrode may be a standard hydrogen electrode (SHE), a normal hydrogen electrode (NHE), a reversible hydrogen electrode (RHE), a saturated calomel electrode (SCE), a copper-copper (II) sulfate electrode (CSE), a silver chloride electrode (Ag/AgCl), a pH-electrode, a palladium-hydrogen electrode, a dynamic hydrogen electrode (DHE), a mercury-mercurous sulfate electrode, or some other type of electrode. In a preferred embodiment, a reference electrode is present and is an Ag/AgCl electrode. However, in some embodiments, the electrochemical cell does not include the reference electrode.

The electrochemical cell is at least partially submerged in an aqueous solution containing ions of a salt, preferably 50%, preferably 60%, or more preferably at least 70%. Preferably, to maintain uniform concentrations and/or temperatures of the aqueous solution, the aqueous solution may be stirred or agitated during the step of the subjecting. The stirring or agitating may be done intermittently or continuously. This stirring or agitating may be done by a magnetic stir bar, a stirring rod, an impeller, a shaking platform, a pump, a sonicator, a gas bubbler, or some other device. Preferably, the stirring is done by an impeller or a magnetic stir bar.

The aqueous solution may include water and a salt. The water may be tap water, distilled water, bi-distilled water, deionized water, deionized distilled water, reverse osmosis water, and/or some other water. The aqueous solution has a salt concentration of 0.05-2 molar (M), preferably 0.1-1 M. In a preferred embodiment, the aqueous solution has a salt concentration of 0.5 M. In some embodiments, the salt is an alkali or alkaline earth metal salt. In some embodiments, the salt includes at least one of lithium, sodium, potassium, magnesium, calcium, chlorine, iodine, bromine, carbonate, and nitrate. In an embodiment, the salt is NaCl. The concentration of ions in the aqueous solution is in the range of 1-10,000 mg/L, preferably 10-1,000 mg/L, or 100-500 mg/L.

In one embodiment, the potential may be applied to the electrodes by a battery, such as a battery including one or more electrochemical cells of alkaline, lithium, lithium-ion, nickel-cadmium, nickel metal hydride, zinc-air, silver oxide, and/or carbon-zinc. In another embodiment, the potential may be applied through a potentiostat or some other source of direct current, such as a photovoltaic cell. In one embodiment, a potentiostat may be powered by an AC adaptor plugged into a standard building or home electric utility line. In one embodiment, the potentiostat may connect with a reference electrode in the electrolyte solution. Preferably, the potentiostat can supply a relatively stable voltage or potential. For example, in one embodiment, the electrochemical cell is subjected to a voltage that does not vary by more than 5%, preferably by no more than 3%, preferably by no more than 1.5% of an average value throughout the subjecting. In another embodiment, the voltage may be modulated, such as increased or decreased linearly, applied as pulses, or applied with an alternating current.

In some embodiments, the electrode has a specific capacitance of 40-50 F/g, 42-48 F/g, or 44-46 F/g. The specific capacitance does not change by more than 10%, preferably 5%, 3%, or 1% following 10,000 charge-discharge cycles.

On applying the potential, at least a portion of ions in the aqueous solution adsorb to the electrode. At least a portion of the ions are sodium ions, and on applying the potential, sodium titanate is formed on a surface of the TiO₂ nanosheets. In some embodiments, the electrode has an ion adsorption capacity of 30-40 mg per gram of the TiO₂ nanosheets, preferably 32-38 mg/g, or 34-36 mg/g. In some embodiments, the ions can then be desorbed by reversing the polarity of the potential. The ions are then removed, and the electrode is regenerated and is ready to be used again.

While not wishing to be bound to a single theory, it is thought that the formation of crystalline anatase TiO₂ provides a high surface area, low energy barrier for ion insertion, and two-dimensional intercalation path, that make it suitable for electrochemical desalination. Anatase TiO₂ nanosheets provide a high density of surface sites for Na adsorption, which can enhance electrochemical performance for sodium-ion storage. Further, both TiO₂ and Ti₂O₃ are formed resulting in oxygen vacancies which improves the electrical conductivity of the electrode.

### EXAMPLES

The following examples demonstrate a method of making 2-dimensional (2D) TiO₂ nanosheets. The examples are provided solely for illustration and are not to be construed as limitations of the present disclosure, as many variations thereof are possible without departing from the spirit and scope of the present disclosure.

### Example 1: Materials

Titanium (IV) isobutoxide was purchased from Sigma-Aldrich. Analytical reagent-grade dimethylformamide (DMF, 99.5%) was purchased from Fisher Scientific. Methanol was obtained from Scharlau. Sulfuric acid (H₂SO₄, 98%), hydrochloric acid (HCl), and sodium chloride (NaCl) solutions were obtained from Sigma Aldrich and used as received.

### Example 2: Synthesis of 2D Layered TiO₂ Nanosheets

Titanium (IV) isobutoxide was used as a precursor to synthesize various 2D sheets of TiO₂. In the first stage, titanium (IV) isobutoxide (2 g) was added to DMF (27 mL) and heated at 80° C. The TiO₂ that was not further processed at this stage was denoted by S1. S1 (TiO₂) was the material that was obtained after 30 min of heating at 80° C. Subsequently, three types of available solvothermal autoclaves, which had different air gaps or free volumes, were used after the addition of the precursors. The heated titanium (IV) isobutoxide in DMF was transferred into the solvothermal autoclave and kept for 48 h at 150° C. The autoclave was then cooled to room temperature (25° C.). Subsequently, the obtained 2D TiO₂ sheets were collected by centrifugation at 6000 rpm and cleaning by washing several times with methanol. The 2D TiO₂ sheets were called S2, S3, and S4, in accordance with the air gap or free volume of the PTFE autoclaved reactor container of 25, 50, and 250 mL, respectively. 18 mL of the precursor-containing solution was transferred into a 25 mL container. The air gap during the synthesis increased with the distance from S2 to S4. The percentage of the air gap to the total volume of the autoclaves used to synthesize S2, S3, and S4 was 28%, 46%, and 89.2%, respectively.

### Example 3: Fabrication of TiO₂/CP Electrode

The as-prepared 2D TiO₂ sheets were dispersed in DMF and then poured directly onto the surface of carbon paper (CP). Thereafter, the mixture was dried at 60° C. for 12 h. TiO₂ adhered uniformly to the CP without the need for a binder. The prepared electrode was referred to as 2D TiO₂@CP.

### Example 4: Characterization Techniques

X-ray diffraction (XRD) (Malvern Panalytical X'Pert3) was used to examine the TiO₂ nanosheet and electrode structures. The analyses were performed at a scanning rate of 0.04° C./min in the 5-70° range. A field-emission transmission electron microscopy (FE-TEM) system (JEOL JEM2100F) was used to study the morphologies and structures of the samples. The Fourier transform infrared (FTIR) spectra of the TiO₂ nanosheets were recorded using a Thermo Scientific Nicolet Is5 instrument in the range of 500-4000 cm⁻¹.

### Example 5: Electrochemical Measurement Techniques

Electrochemical characterization tests were performed using a multichannel potentiostat (Corrtest CS 310), which was controlled using CS Studio6. A three-electrode setup was used to evaluate electrochemical performance. The counter electrode was a Pt mesh, and the reference electrode was Ag/AgCl. Using an electrochemical setup, the cyclic voltammetry (CV) curves of the electrodes were recorded in a 1 M aqueous NaCl solution in the potential range of 0.2-0.8 V (versus Ag/AgCl). Measurements were performed at scan rates of 100, 50, 30, 10, and 1 mV/s. Na extraction measurements were performed using a 60 mL electrolytic cell; the distance between the electrodes was maintained at 15 mm.

Three electrodes were used to test the electrochemical adsorption and desorption of Na⁺ onto the 2D TiO₂/CP electrode at room temperature. The amount of NaCl aqueous solution used in this experiment was 15 mL, and the Na⁺ ion concentration was maintained at 1000 ppm. 2D TiO₂/CP, Pt mesh, and Ag/AgCl electrodes were used as the working, counter, and reference electrodes, respectively. The working electrode was subjected to a reduction potential of −1 V for the electrochemical adsorption of Na⁺ ions. Equation (1) was used to determine the adsorption capacities of the electrode films (Q):

$$Q = \frac{( {C}_{o} - {C}_{e} ) \times V}{m} \qquad ( 1 )$$

where Cₒ and Cₑ represent the initial and final concentrations, respectively; V represents the volume of the aqueous solution; and m represents the mass of the TiO₂/CP hybrid film. After the TiO₂/CP hybrid film electrode adsorbed the Na⁺ ions, a voltage of 1.0 V was applied as the oxidation potential to achieve Na⁺ desorption.

The desorption ratio of the composite film was calculated using Equation (2):

$$Desorption ratio = \frac{{Q}_{s}}{{Q}_{e}} \qquad ( 2 )$$

where Qₛ represents the amount of Na⁺ ions desorbed into the solution and Qₑ represents the amount of Na⁺ ions adsorbed by the 2D TiO₂/CP film.
The average salt adsorption rate (ASAR, mg g⁻¹ min-1) was calculated based on Equation (3)

$$ASAR = SAC / t \qquad ( 3 )$$

where SAC is the Salt Adsorption Capacity (mg g⁻¹), and t is the desalination time (min).
In general, the power-law relationship between the currents and scan speeds of the CV curves conforms to Equation (4)

$$i = a {v}^{b} \qquad ( 4 )$$

$$Cp = \frac{A}{2 mK Δ V} \qquad ( 5 )$$

where Cₚ is the specific capacitance in F g⁻¹, A is the area in AV, m is the material mass, K is the scan rate of CV in V s⁻¹, and ΔV the potential window of the CV. The error bars in the figures represent the standard deviation (SD).

### Example 6: Structural Characterization

TiO₂ exists in three main crystal structures: anatase, rutile, and brookite. The XRD pattern for each phase is distinctive, with characteristic peaks corresponding to the atomic arrangement in each crystal structure. Anatase TiO₂ has a tetragonal crystal structure with lattice parameters a=3.785 Å and c=9.514 Å, and its XRD pattern is characterized by sharp peaks at 2θ=25.3°, 37.8°, 48.1°, 54.0°, and 62.7°. Rutile TiO₂ has a tetragonal crystal structure with lattice parameters a=4.594 Å and c=2.958 Å, and its XRD pattern is characterized by sharp peaks at 2θ=27.5°, 36.1°, 41.2°, 54.3°, 56.6°, and 69.1°. Brookite TiO₂ has an orthorhombic crystal structure with lattice parameters a=5.517 Å, b=9.181 Å, and c=5.149 Å, and its XRD pattern is characterized by sharp peaks at 2θ=26.1°, 37.9°, 39.6°, 41.0°, 49.3°, 54.5°, and 64.0°.

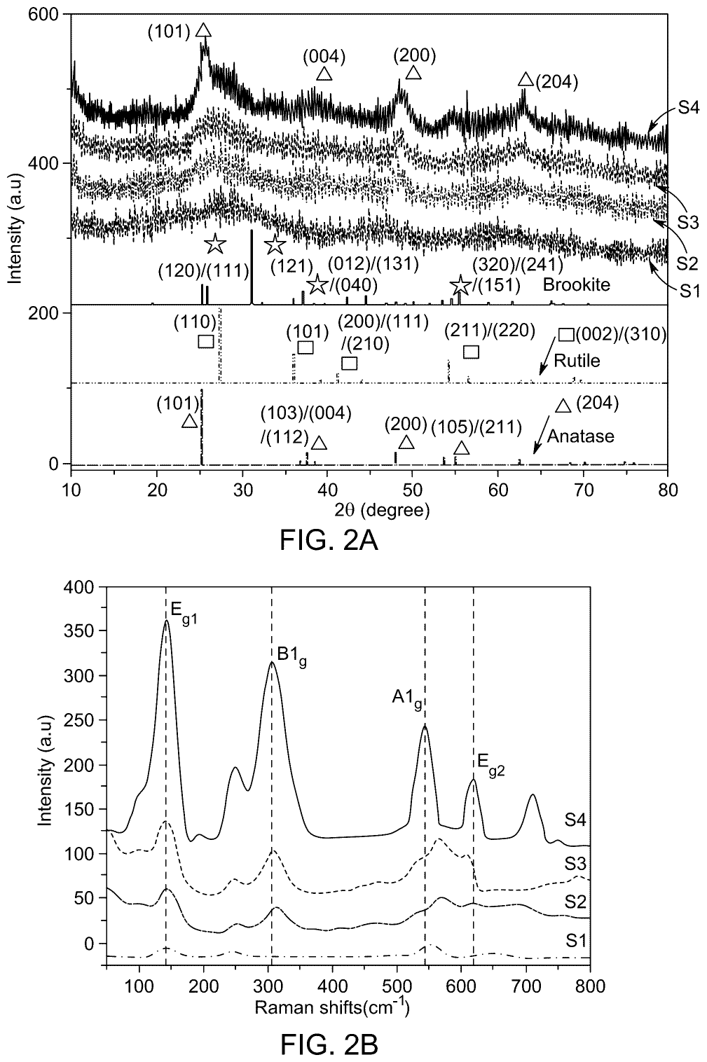

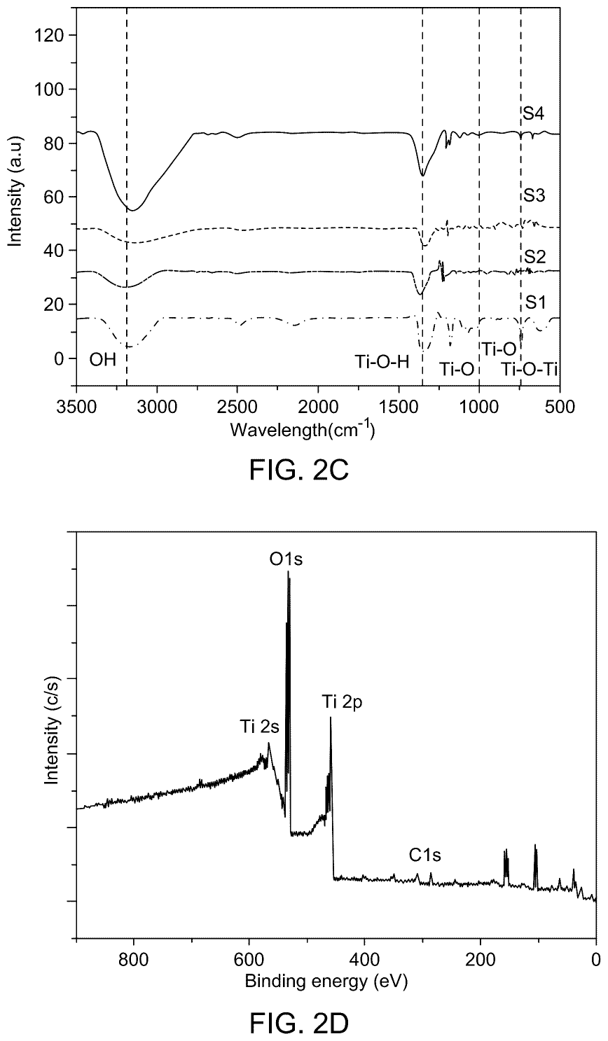

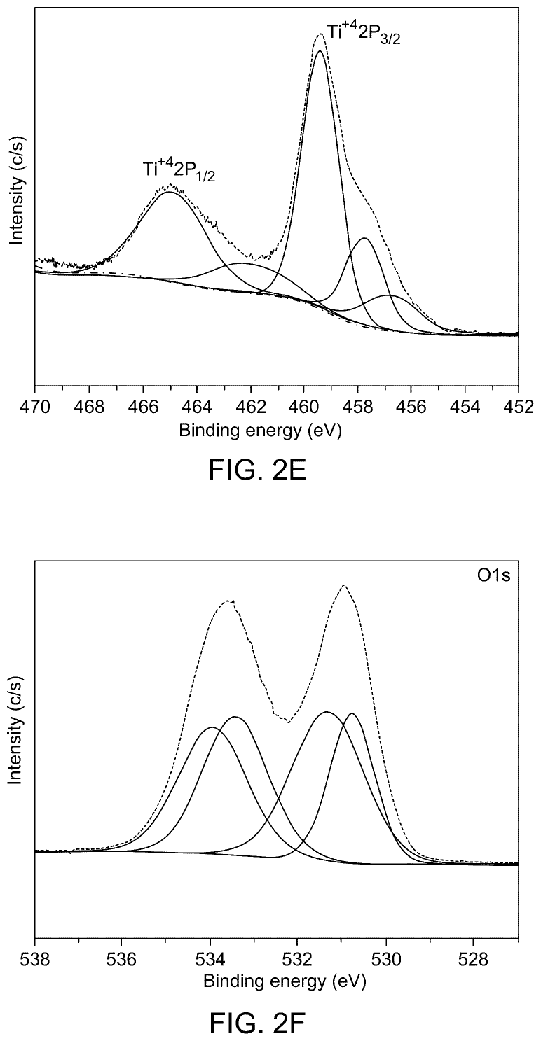

FIG. 2A depicts the XRD pattern of the four prepared TiO₂ materials under different conditions. The primary diffraction peaks of the synthesized materials were found to match the anatase phase of TiO₂; that is, the (101), (004), (200), and (211) crystal faces of anatase TiO₂ are represented by four diffraction peaks at 20 of 25.8°, 37.7°, 47.8°, and 55.0°.

Furthermore, the absence of diffraction peaks at 27° or 31° indicates that the samples are not contaminated by rutile or brookite impurities. As can be concluded based on comparison with the standard pattern of anatase TiO₂ (JCPDS no. 21-1272), the samples synthesized under various conditions were entirely composed of a pure anatase phase. In addition, the peak intensity related to samples S1, S2, S3, and S4 increased by increasing the air gap during solvothermal synthesis; the anatase peak (at) 25.8° was sharper for sample S4 than for the other samples, and the sharpness increased from S1 to S4, thereby confirming the increase in the 2D TiO₂ sheet crystallinity. Moreover, the average crystallite size of the S4, estimated by the Scherrer and the Williamson-Hall models, was 1.33 and 2.01 nm, respectively, confirming the nano-crystallinity of the synthesized materials.

Raman spectroscopy was used to evaluate and confirm the structure of the synthesized 2D materials. The Raman spectrum of TiO₂ exhibits several peaks that can be assigned to specific vibrational modes (FIG. 2B). The peak at approximately 144 cm⁻¹ is known as the E_{g} mode and is associated with the symmetric stretching of Ti—O bonds in the crystal lattice. The peak at approximately 386 cm 1 is known as the B1_{g} mode and is associated with the bending of Ti—O—Ti bonds. The peak at approximately 519 cm⁻¹ is known as the A1g mode and is associated with the symmetric stretching of Ti—O bonds. The peak at approximately 631 cm⁻¹ is known as the E_{g} mode and is associated with the symmetric bending of Ti—O bonds and are characteristic of anatase TiO₂. The Raman spectra are consistent with the results obtained by XRD, with the intensity of the characteristic peak of the anatase phase at 144 increasing from S1 to S4 and thus confirming that the air-gap protocol used in preparing the TiO₂ nanosheets allows the control of their crystallinity.

In the FTIR spectrum of TiO₂ (FIG. 2C), several bands identify the material. These bands originated from the vibrational modes of the Ti—O bonds in the crystal lattice. The resulting spectrum provided information on the vibrational modes of the sample. O—H stretching is detected at approximately 1623 and 3400 cm⁻¹, indicating that the material is hydroxylated. Ti—O stretching is indicated by vibration that occurs at approximately 600-800 cm⁻¹ and is ascribed to the stretching of the Ti—O bond in the anatase structure. Ti—O bending is characterized by the vibration that occurs at approximately 400-500 cm⁻¹ and is attributed to the bending of the Ti—O bond in the anatase structure; notably, no additional vibrational peaks that can be associated with the air-gap-assisted solvothermal conditions are observed; all samples exhibit the same vibrational peaks with minimal difference in peak intensity.

X-ray photoelectron spectroscopy (XPS) is an analytical technique that provides information on the chemical state and composition of a material surface. The XPS survey spectra of the TiO₂ thin films are presented in FIG. 2D, which shows that the presence of the carbon peak is due to instrument impurities. FIG. 2E shows a high-resolution XPS spectrum of pure TiO₂ film; the Ti 2p XPS spectrum displays two peaks at 458.36 and 464.88 eV, which are attributed to Ti⁴⁺ The area ratio between these peaks is 2:1, which is stoichiometrically consistent. The difference in binding energy between the Ti 2p_{3/2} and Ti 2p_{1/2} peaks is 5.45 eV, which agrees with the known values for Ti⁴⁺—O bonding in TiO₂. Additionally, the shoulder Ti 2p_{1/2} at the binding energy of 461.98 eV corresponds to the oxidation state Ti³⁺ in Ti₂O₃. These findings indicate that the film generates both TiO₂ and Ti₂O₃ during its formation. The presence of Ti³⁺ can be attributed to the oxygen vacancies generated by the unique method, which consists of the variation in air gap during the solvothermal process; the oxygen vacancies are generated by the calcination temperature and air plasma treatment.

The O 1s spectrum displays two peaks at 530.77 and 533.42 eV, which are associated with the lattice and non-lattice oxygens of TiO₂, respectively (FIG. 2F). The binding energy difference between the Ti 2p_{3/2} peak and the O 1s lattice oxygen peak is 72.7 eV, which is close to that observed for anatase TiO₂ (71.4 eV). The relative peak areas of the lattice and non-lattice oxygen peaks provide information regarding the surface structure of the material, with most oxygen atoms being in the lattice sites. The similarity between the binding-energy differences observed for TiO₂ and anatase TiO₂ indicates that the material has a surface structure and bonding environment similar to that of anatase TiO₂. Notably, the inclusion of oxygen vacancies naturally improves the electrical conductivity of the 2D TiO₂@CP electrode, which is beneficial for advanced sodium storage.

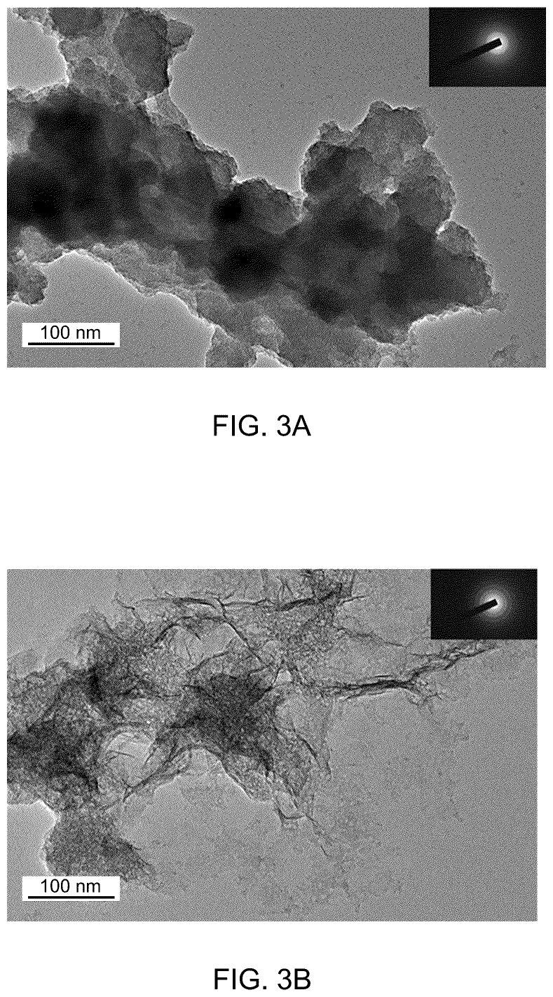

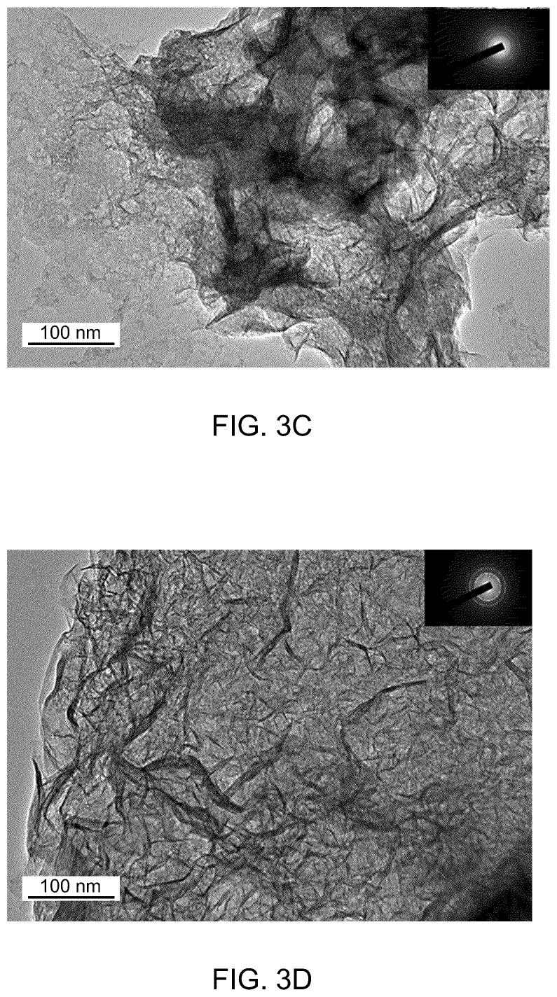

TEM showed the remarkable transformation of TiO₂ into 2D sheets as the air gap in the solvothermal autoclave was varied (FIG. 3A-FIG. 3D). As evidently seen in the TEM images, the resulting nanosheets prepared with various air gaps exhibited a 2D layered structure with different ranges of crystallinity. The TiO₂ sheets started turning from multiple layers to a few or ultrathin layers. FIGS. 3A-3D shows that the thickness of the TiO₂ nanosheets is in the range of atomic dimensions, whereas their lateral dimensions are in the range of micrometers. However, the TEM image (FIG. 3A) shows the low crystallinity of the pristine TiO₂ nanosheets, given that the lattice fringes are not clearly visible and as confirmed by a diffraction spot (inset FIG. 3A). S1, TiO₂ was synthesized simply by heating in an open atmosphere at 80° C. The TiO₂ appeared multilayer, and most of it was amorphous and lacked crystallinity, as was evident from the selected-area electron diffraction (SAED) and XRD patterns of S1 TiO₂. The morphology of TiO₂ completely changed when the air-gap-assisted solvothermal process was adopted to synthesize the material. FIG. 3B-FIG. 3D illustrates the effects of different air gaps on the structure and crystallinity of the TiO₂ nanosheets. As the air gap in the reactor increased, the 2D nanosheets gradually became crystalline. The sheet-like structure of TiO₂ was recognizable in all air-gap-assisted solvothermal syntheses. FIG. 3D shows the TiO₂ nanosheet prepared at a larger air gap, which has a thin, paper-like appearance and is characterized by a high number of wrinkles; this appearance is similar to that of the graphene nanosheet. Thus, the TEM images confirm that the TiO₂ nanosheets have a two-dimensional shape and a layered structure.

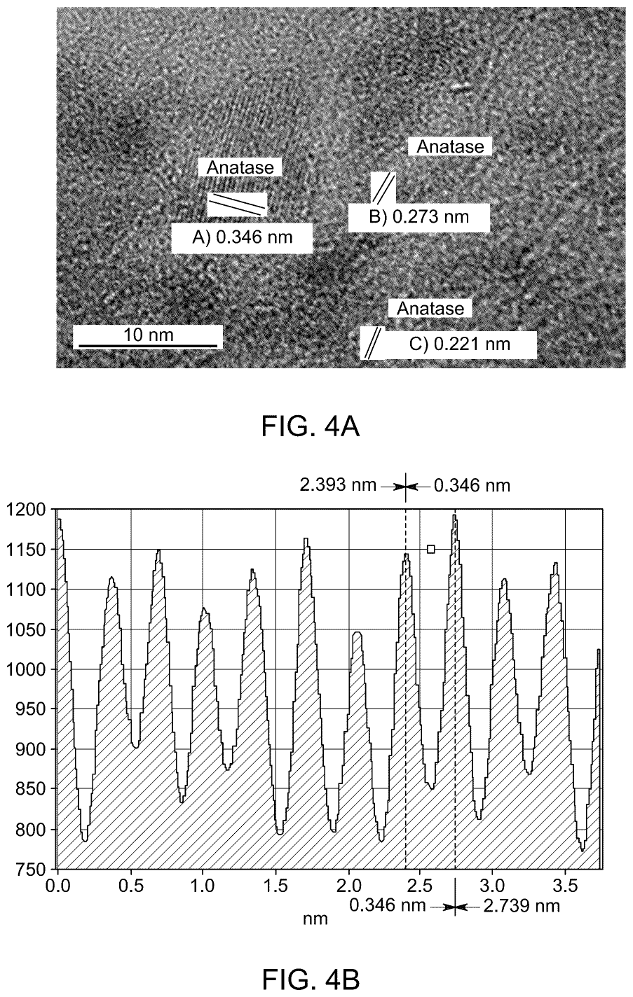

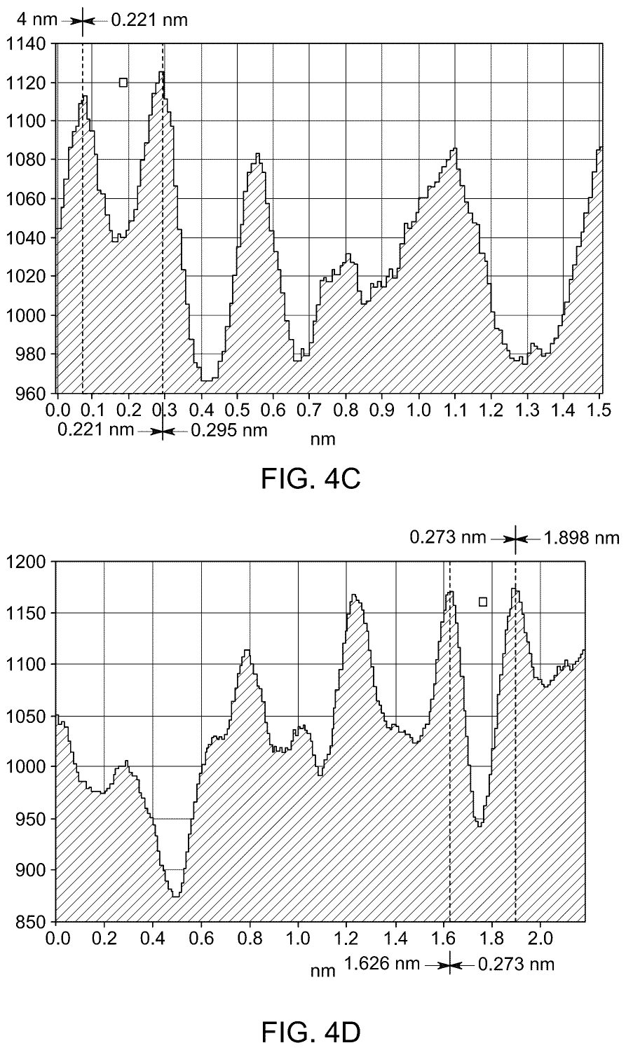

HRTEM analysis of sample S4 (FIGS. 4A-4D) reveals that the lattice fringes have an interlayer distance of 0.346 nm, which approximately correlates to the lattice spacing of the (101) planes of anatase TiO₂, which is 0.351 nm. The (200) planes of anatase TiO₂ could be identified by a lattice spacing of approximately 0.189 nm, whereas a lattice spacing of approximately 0.235 nm corresponding to the (001) planes of anatase TiO₂. This observation is consistent with the XRD study results. The results of TEM and SAED analyses show that varied free spaces affect not only the crystalline phase and crystallinity of the TiO₂ nanostructures but also their morphologies. Anatase TiO₂ is a suitable material for Na electrosorption because of its high surface area, unique surface chemistry, and good electrochemical stability. The presence of the {001} and {200} facets in anatase TiO₂ nanosheets can provide a high density of surface sites for Na adsorption, which can enhance electrochemical performance for sodium-ion storage. Additionally, anatase TiO₂ exhibits a reversible intercalation/deintercalation of sodium ions, making it a promising candidate for use in sodium-ion batteries.

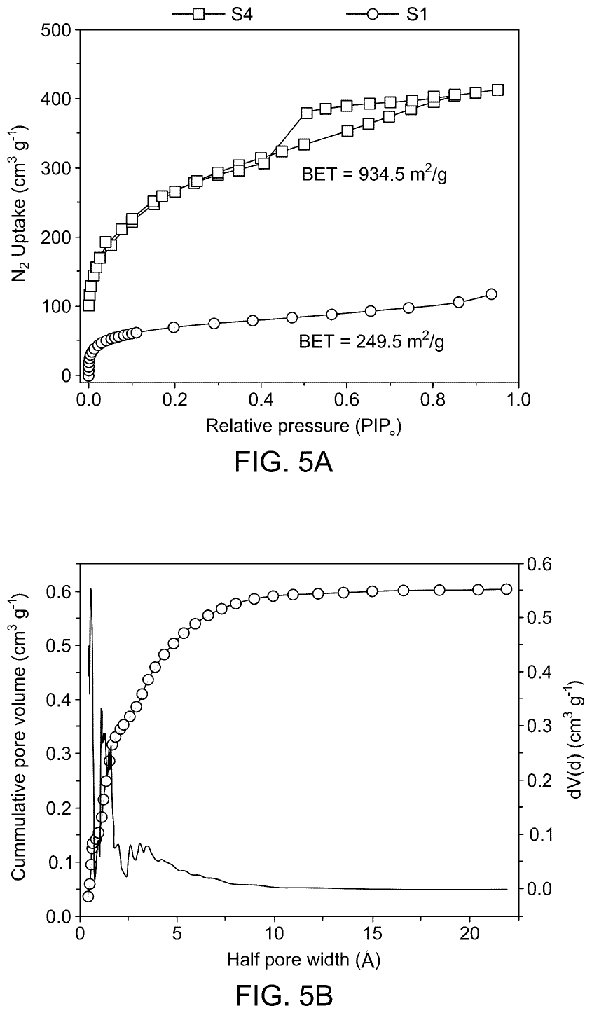

Meanwhile, the surface area analysis of the pristine (S1) and the air gap-assisted crystalline (S4) nanosheets were conducted and presented in FIG. 5A. The N₂ adsorption isotherms of both materials at 77 K indicate that S1 exhibits microporous features, while S4 has resulted in an increase in mesoporosity as depicted by the hysteresis loop on the BET isotherm due to the air gap solvothermal synthesis of S4. The corresponding increase in N₂ uptake on S4 further confirms the layering of the 2D nanosheets and the increase in the inter-layer spacing. Consequently, the BET surface area of S1 was estimated at 249.5 m²/g, while S4 has a value of 934.5 m²/g. Furthermore, the pore size distribution estimated by the non-linear DFT method (FIG. 5B) revealed that S4 has an average pore size of 0.60 nm, in contrast to the 0.02 nm recorded for S1, making S4 a potential material for the efficient electrosorption of Na⁺ ions.

### Example 7: Electrochemical Characterization

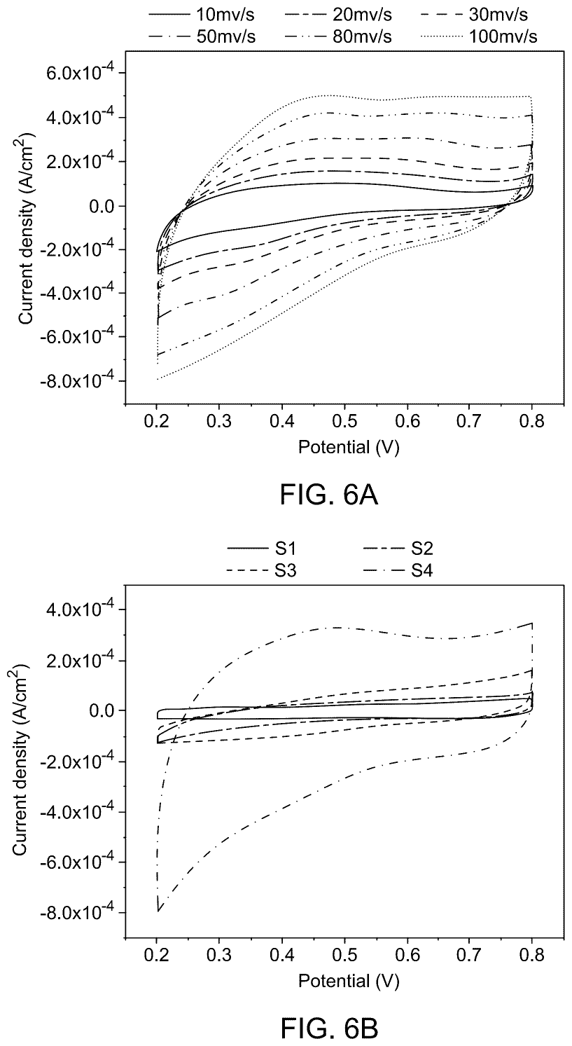

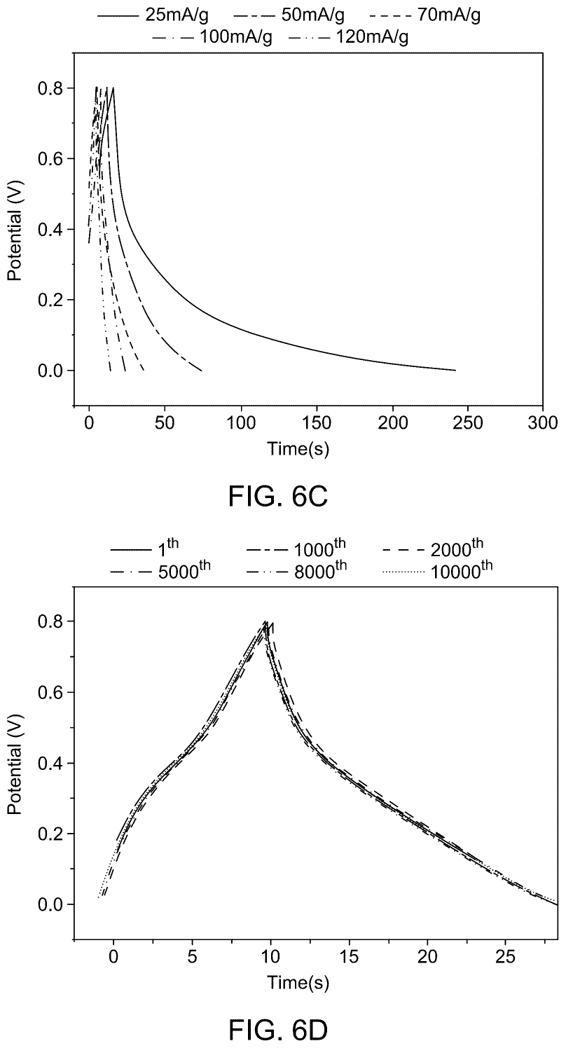

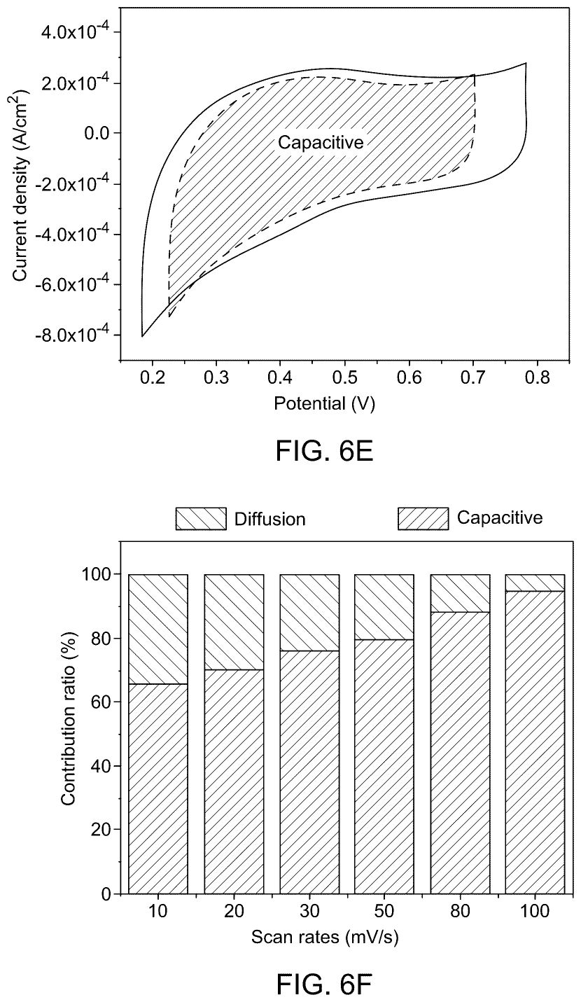

All electrochemical measurements were performed in a 1.0 M NaCl aqueous solution using a three-electrode setup consisting of a platinum counter electrode, Ag/AgCl reference electrode, and 2D TiO₂@CP working electrode. The 2D TiO₂@CP CV curves (FIG. 6A) show quasi-rectangular geometries with no evident redox peaks within the potential range ranging from 0.2 V to 0.8 V. The broad redox peaks shown at 0.3 and 0.4 V correspond to the insertion/de-insertion of Na⁺ based on the redox couple Ti⁴⁺/Ti³⁺. During the CV scans and owing to the layered structure of the material, sodium titanate was formed. Sodium titanates are a family of chemical compounds containing Na and titanium oxide (TiOₓ) in various stoichiometries. They exhibit a layered crystal structure consisting of alternating sheets of titanium oxide (TiO₆) and sodium ions. This architectural design generated accessible tunnels along the b-axis, thereby facilitating Na⁺ diffusion. FIG. 6B shows a CV scan at 10 mV/s for the 2D fabricated electrodes. For the TiO₂ nanosheets prepared under different conditions (S1, S2, S3, and S4), all of the CV curves show quasi-rectangular geometries with no evident redox peaks within a potential range of 0.2-0.8 V. Equation (5) was used to calculate the specific capacity from the CV scan of the different materials; the specific capacity of the electrode fabricated with S4 was higher than that of the electrode fabricated using materials S1, S2, and S3, with specific capacities of 4.993, 6.881 and 7.875 F g⁻¹ respectively; by comparison, that of S4 was estimated to be 45.68 F g⁻¹. This confirms the high performance of S4 because of its high surface area, unique surface chemistry, and good electrochemical stability.

2D TiO₂@CP demonstrated superior capacitive performance when the scan rate was varied from 10 mV s⁻¹ to 100 mV s⁻¹ because of its enhanced enclosed area provided by its CV curve. As shown above, at a scanning rate of 10 mV s⁻¹, the specific capacitance of 2D TiO₂@CP was approximately 49.43 mA h g 1, and its shape remained stable as the scanning speed increased. The GCD measurements in a 1 M NaCl solution did not reveal any distinct redox platform, indicating that the 2D TiO₂@CP electrode is a pseudocapacitive Faradaic electrode material, implying that the Faradaic phenomenon occurs on or near the surface of the electrode material (FIG. 6C). The electrode exhibited outstanding performance and cycling stability in NaCl solution, with minimal changes in the specific capacity and retention rate even after 10000 cycles; these results demonstrate its high electrochemical stability in water (FIG. 6D). Consequently, the extraction of Na⁺ can be attributed to Faradaic and surface redox reactions, with the specific reaction equation given as follows:

$${Ti}^{4 +} O 2 + {x Na}^{+ 2} + x e - ↔ {Na}^{+} ( {Ti}^{3 +} {x Ti}^{4 +} 1 - x ) O 2 ( x \leq 1 )$$

The behavior of the 2D TiO₂@CP electrode material during the charge-discharge process was influenced by the redox reaction and ion diffusion. As demonstrated by performing tests at various scanning rates, the electrode material exhibited pseudocapacitive behavior owing to its small volume and large surface area. The b value calculated using Equation (4) was 0.76, indicating that the redox reaction is controlled by ion diffusion (inset of FIG. 6E). To determine the respective contributions of diffusion-controlled and pseudocapacitive behavior to the total sodium storage, equation 6 is used:

$$i ( v ) = {k}_{1} ν + {k}_{2} {ν}^{1 / 2} \qquad ( 6 )$$

where i(v), k₁v, and k₂v^{1/2} denote the total capacitive-controlled, and diffusion-controlled currents, respectively. To obtain the constants k₁ and k₂, the i(v)/v^{1/2}−v^{1/2} plots of the CV curves at different scan rates were linearly fitted. Quantitative analyses revealed that at a scan rate of 100 mV s 1, the pseudo-capacitance contribution to the total Na⁺ storage was 94%, whereas the contribution of diffusing charge was only 6% (FIG. 6E), corresponding to Na⁺ intercalation/deintercalation in the anatase TiO₂ nanosheets. Most of the ion storage occurred on the surface of the two-dimensional TiO₂ nanosheets. As the scanning rate decreased, the diffusion contribution increased, whereas the capacitance contribution decreased, as shown in FIG. 6F. At 10 mV s⁻¹, the capacitance contribution of the 2D TiO₂@CP electrode was 65% of its total capacity, indicating that the electrode material has promising applications in pseudocapacitive sodium storage and electrosorption desalination.

### Example 8: Adsorption/Desorption of Na⁺ Ions on the TiO₂ Composite Film

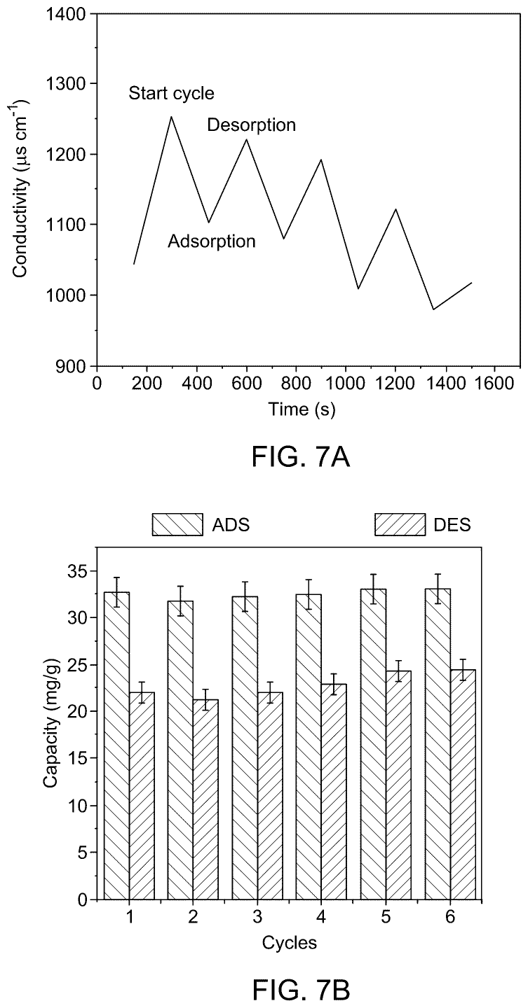

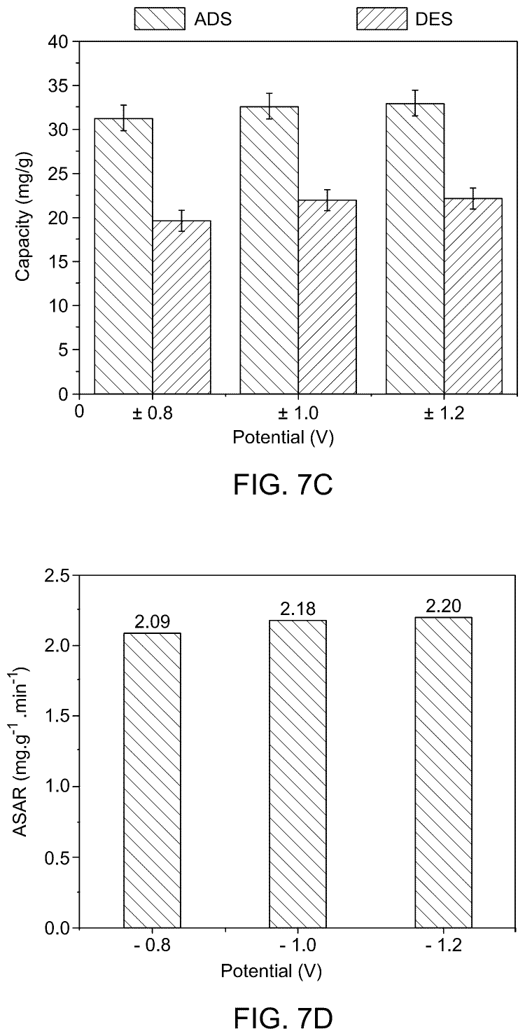

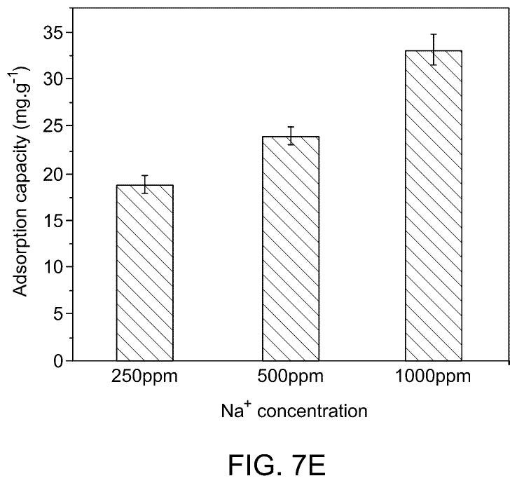

A three-electrode configuration was used at room temperature to examine the electrosorption-desalination performance of the 2D TiO₂/CP electrodes. FIG. 7A illustrates the trend of conductivity versus time. Evidently, the conductivity decreased when the negative potential was applied, thus confirming the adsorption of Na⁺ ions during the charging process. During the discharging phase, Na⁺ ions were desorbed from the electrolyte, resulting in an increase in conductivity. A reversible reaction occurred during discharge, releasing Na⁺ and Cl-into the electrolyte and increasing the electrical conductivity. Furthermore, the 2D TiO₂/CP electrode exhibited good electrosorption-desalination performance stability after six cycles without any substantial decline (FIG. 7D). The desalination capacity of the 2D TiO₂/CP electrode was 33.19 mg g 1 as determined using Equation (1).

To study the effects of various applied potentials, electrosorption-desalination tests were carried out on the 2D TiO₂/CP electrode using a three-electrode setup using a solution with a NaCl concentration of 1,000 mg L⁻¹. The applied potentials for the 2D TiO₂/CP electrodes were in the ranges of 0.8 to −0.8, 1.0 to −1.0, and 1.2 to −1.2 V, respectively, and the adsorption time was fixed at 15 min. Various applied potential ranges for SAC are shown in FIG. 7C. The average adsorption capacity values for −0.8 V, −1.0 V, and −1.2 V were 31.33, 32.73, and 33.023 mg g⁻¹, respectively, indicating that the adsorption capacity increases with increasing applied potential. Meanwhile, the typical salt adsorption rates were 2.09, 2.18, and 2.20 mg g⁻¹ min-1 at the same applied potential (FIG. 7D). The same trend was observed: the ASAR increased proportionally with the applied potential because driving forces of the Na⁺ and Cl⁻ ions increased under stronger electric fields at higher voltages, resulting higher ASARs. In addition, the electrosorption process was performed at different initial NaCl concentrations, and the results showed that the increase in the initial NaCl concentration led to the increase in adsorption capacity; as seen in FIG. 7E, the SAC values were 18.81, 23.95, and 33.19 mg g⁻¹ for the initial Na⁺ concentrations of 250, 500, and 1000 ppm, respectively. Even at low NaCl concentration (250 ppm), an acceptable adsorption capacity can be achieved. Thus, 2D TiO₂ produced by the air-gap-assisted solvothermal process was highly activated to desalinate water from low-salt to high-salt-containing water, thus making it a multipurpose electroactive material.

TABLE 1
Comparisons between the desalination capacities of different types of electrodes

| | Salt | | | | |
|---|---|---|---|---|---|
| | adsorption | Specific | | | |
| | capacity | capacity | | | |
| Material | (mg g⁻¹) | (F g⁻¹) | Concentration | | Ref. |
| Coconut-shell | 9.15 | 112 | z | | [See: Huynh, L. T. N. |
| activated | | | | | et al. Enhanced |
| carbon (AC) | | | | | electrosorption of |
| | | | | | NaCl and nickel(II) in |
| | | | | | capacitive |
| | | | | | deionization by CO₂ |
| | | | | | activation coconut- |
| | | | | | shell activated carbon. |
| | | | | | Carbon Letters 32, |
| | | | | | 1531-1540 (2022)] |
| AC particle | 15.52 | — | 500 | mg L⁻¹ | [See: Dou, C. et al. |
| electrode | | | | | Chemical modification |
| modified by | | | | | of carbon particles to |
| phosphoric | | | | | enhance the electrosorption |
| acid | | | | | of capacitive |
| | | | | | deionization process. |
| | | | | | Journal of Water |
| | | | | | Reuse and Desalination |
| | | | | | 10, 57-69 (2020)] |
| 3D-Na⁺—Ti₃C₂Tₓ | 16.2 | 143.2 | 100 | mg L⁻¹ | [See: Chen, B. et al. |
| | | | | | High-performance |
| | | | | | capacitive |
| | | | | | deionization using 3D |
| | | | | | porous Ti₃C₂Tₓ with |
| | | | | | improved conductivity. |
| | | | | | Journal of |
| | | | | | Electroanalytical |
| | | | | | Chemistry 895, |
| | | | | | 115515 (2021)] |
| Graphene/CN | 28.62 | 280 | 600 | mg L⁻¹ | [See: Arora, N., |
| Ts/ZnO | | | | | Banat, F., Bharath, G. |
| (FGC-ZnO) | | | | | & Alhseinat, E. |
| | | | | | Capacitive |
| | | | | | deionization of NaCl |
| | | | | | from saline solution |
| | | | | | using graphene/CNTs/ZnO |
| | | | | | NPs based electrodes. |
| | | | | | J Phys D Appl Phys |
| | | | | | 52, 455304 (2019)] |
| ZIF-8 derived | 8.52 | 160.8 | 1M | | [See: Liu, N. L. et al. |
| polyhedron | | | | | ZIF-8 Derived, |
| particles | | | | | Nitrogen-Doped |
| | | | | | Porous Electrodes of |
| | | | | | Carbon Polyhedron |
| | | | | | Particles for High- |
| | | | | | Performance |
| | | | | | Electrosorption of Salt |
| | | | | | Ions. Scientific |
| | | | | | Reports 2016 6: 1 6, |
| | | | | | 1-7 (2016)] |
| Nitrogen- | 3.98 | 691.78 | | | [See: Yasin, A. S., |
| TiO₂/ZrO₂ | | | | | Mohamed, I. M. A., |
| nanofibers | | | | | Mousa, H. M., Park, |
| incorporated | | | | | C. H. & Kim, C. S. |
| AC (NACTZ) | | | | | Facile synthesis of |
| | | | | | TiO₂/ZrO₂ |
| | | | | | nanofibers/nitrogen |
| | | | | | co-doped activated |
| | | | | | carbon to enhance the |
| | | | | | desalination and |
| | | | | | bacterial inactivation |
| | | | | | via capacitive |
| | | | | | deionization. Scientific |
| | | | | | Reports 2018 8: 1 8, |
| | | | | | 1-14 (2018)] |
| MoS₂/CNT | 25 | 75 | 500 | mM | [See: Srimuk, P. et al. |
| | | | | | Faradaic deionization |
| | | | | | of brackish and sea |
| | | | | | water via |
| | | | | | pseudocapacitive |
| | | | | | cation and anion |
| | | | | | intercalation into few- |
| | | | | | layered molybdenum |
| | | | | | disulfide. J Mater |
| | | | | | Chem A Mater 5, |
| | | | | | 15640-15649 (2017)] |
| 2D-layered | 33.19 | 45.68 | 1000 | mg L⁻¹ | This work |

TiO₂

The electrode constructed using 2D TiO₂ exhibited superior desalination capacity to those of other comparable electrodes (Table 1), which is due to the synergistic effect of the lamellar structure, shorter ionic diffusion path, more active adsorption sites, and pseudocapacitive behavior. Furthermore, compared with other materials, this unique 2D layered TiO₂ had a larger desalination capacity and lower specific capacity. Compared with closed materials, a higher SAC for a smaller specific capacitance indicates a higher usage efficiency of the unique layered 2D TiO₂ material.

1: A method of making TiO₂ nanosheets, comprising:
heating a titanium (IV) alkoxide in a solvent to a temperature of 70-100° C. for 10-100 minutes to form a heated titanium (IV) alkoxide;
reacting the heated titanium (IV) alkoxide in a solvothermal autoclave for 12-60 hours at a temperature of 100-200° C. to form a reaction mixture; and
separating the TiO₂ nanosheets from the reaction mixture,
wherein the solvothermal autoclave has an air gap of 20-95 vol % relative to a total volume of the solvothermal autoclave,
wherein a length and a width of the TiO₂ nanosheets are greater than 1 μm, and
wherein the TiO₂ nanosheets have a BET surface area of 900-1,000 m²/g.

2: The method of claim 1, wherein a thickness of the TiO₂ nanosheets of less than 3 nm.

3: The method of claim 1, wherein the TiO₂ nanosheets are layered on top of one another with an average interlayer spacing of 0.25-0.5 nm.

4: The method of claim 1, wherein the TiO₂ nanosheets comprise wrinkles.

5: The method of claim 1, wherein the TiO₂ nanosheets have an average pore size of 0.4-1.0 nm.

6: The method of claim 1, wherein the TiO₂ nanosheets comprise anatase TiO₂.

7: The method of claim 1, wherein the TiO₂ nanosheets do not comprise rutile or brookite TiO₂.

8: The method of claim 1, wherein the TiO₂ nanosheets have an average crystallite size of 1-2.5 nm.

9: The method of claim 1, wherein the TiO₂ nanosheets are at least 30% crystalline.

10: The method of claim 1, wherein the TiO₂ nanosheets comprise both TiO₂ and Ti₂O₃.

11: TiO₂ nanosheets made by the method of claim 1.

12: An electrode, comprising:
the TiO₂ nanosheets of claim 11; and
a substrate,
wherein the TiO₂ nanosheets are dispersed on a surface of the substrate.

13: A method of desalinating an aqueous solution, comprising:
applying a potential of −0.1 to −2.0 V to an electrochemical cell comprising the electrode of claim 12 and a counter electrode,
wherein the electrochemical cell is at least partially submerged in the aqueous solution, and
wherein following the applying the potential at least a portion of ions in the aqueous solution adsorb to the electrode.

14: A method of claim 13, wherein the electrode has a specific capacitance of 40-50 F/g.

15: A method of claim 14, wherein the specific capacitance does not change by more than 10% following 10,000 charge discharge cycles.

16: A method of claim 13, wherein at least a portion of the ions are sodium ions and on applying the potential sodium titanate is formed.

17: A method of claim 13, wherein the electrode has an ion adsorption capacity of 30-40 mg per gram of the TiO₂ nanosheets.

18: A method of claim 13, wherein the aqueous solution has an ion concentration of 1-10,000 mg/L.
